(19) United States
(12) Patent Application Publication
(10) Pub. No.: US 2025/0292611 A1
(43) Pub. Date: Sep. 18, 2025

(54) APPARATUS FOR ULTRASONIC FINGERPRINT IDENTIFICATION AND ELECTRONIC DEVICE

(71) Applicant: HUIKE (SINGAPORE) HOLDING PTE. LTD., Singapore (SG)

(72) Inventor: Canhong DU, Shenzhen (CN)

(73) Assignee: HUIKE (SINGAPORE) HOLDING PTE. LTD., Singapore (SG)

(21) Appl. No.: 19/223,275

(22) Filed: May 30, 2025

Related U.S. Application Data
(63) Continuation of application No. PCT/IB2024/058080, filed on Aug. 20, 2024.

(30) Foreign Application Priority Data
Aug. 24, 2023 (CN) 202311078646.7

(51) Int. Cl. G06V 40/13; G06F 3/041; G06F 3/043; G06V 40/12

(52) U.S. Cl. CPC G06V 40/1306; G06F 3/041662; G06F 3/0433; G06V 40/1365

(57) ABSTRACT

An apparatus for ultrasonic fingerprint identification and an electronic device are provided. The apparatus is arranged below a cover plate of the electronic device to implement ultrasonic fingerprint identification. The apparatus includes an ultrasonic fingerprint identification chip, a matching layer stacked on the ultrasonic fingerprint identification chip, and a second electrode arranged with respect to the matching layer. The ultrasonic fingerprint identification chip includes a substrate, a first electrode, a pixel electrode array, and a piezoelectric layer. The first electrode is configured to receive a drive signal to drive the piezoelectric layer to excite an ultrasonic signal, and the second electrode is configured to receive a second drive signal to detect self-capacitance between the second electrode and a finger to implement fingerprint identification of the finger.

### CROSS REFERENCE

The present disclosure is a continuation application of PCT/IB2024/058080 filed on Aug. 20, 2024, which claims priority to Chinese patent application for invention with the application No. 202311078646.7 titled “APPARATUS FOR ULTRASONIC FINGERPRINT IDENTIFICATION AND ELECTRONIC DEVICE” and filed on Aug. 24, 2023, the entire content of which is incorporated herein by reference.

### TECHNICAL FIELD

The present disclosure relates to the technical field of fingerprint identification, and particularly relates to an apparatus for ultrasonic fingerprint identification and an electronic device.

### BACKGROUND

At present, an ultrasonic fingerprint identification technology is widely used in organic light-emitting diode (OLED) displays of electronic devices. The ultrasonic fingerprint identification technology may also be used below a non-OLED display, such as below a cover plate to form an apparatus for ultrasonic fingerprint identification as shown in FIG. 1.

As shown in FIG. 1, an ultrasonic fingerprint identification chip 100 is attached below a cover plate 300 through a matching layer 200. The ultrasonic fingerprint identification chip 100 comprises a first electrode 101, a pixel electrode array 102, and a piezoelectric layer 103 sandwiched therebetween. When the apparatus for ultrasonic fingerprint identification works in an ultrasonic mode, a drive signal drives a first electrode 101 to generate and receive ultrasound; when it works in finger touch detection, capacitance C1 between the first electrode 101 and a finger is detected based on the touch sensing signal. When the finger presses a region where an ultrasonic fingerprint is positioned, the capacitance C1 will increase, thereby determining touch sensing of the finger.

However, when the drive signal and the touch sensing signal share the first electrode 101 as shown in FIG. 1, there are the following problems:
first, the drive signal usually drives a voltage of tens or even hundreds of volts. This voltage is too high for a touch sensing circuit connected with the touch sensing signal, which is thus not conducive to chip circuit design;
second, the first electrode 101 and the pixel electrode array 102 sandwich the piezoelectric layer 103, which may be equivalent to a plate capacitor C0 with a very large capacitance value (usually up to 150 pF), while capacitance C1 generated by finger pressing is only of an order of magnitude of 1 pF, so that C0 is much larger than C1, and so that change of the touch sensing signal is insensitive to C1, that is, the presence of C0 will cause detection sensitivity of C1 to become very low, thereby reducing detection sensitivity of the apparatus for ultrasonic fingerprint identification; and
moreover, the design of sharing the first electrode 101 must require the first electrode 101 to face the finger to implement finger touch detection, which is thus not conducive to flexible regulation of a stacked layer in a practical application of the apparatus for ultrasonic fingerprint identification, and imposes limitation on the structure of the apparatus for ultrasonic fingerprint identification.

### SUMMARY

The present disclosure provides an apparatus for ultrasonic fingerprint identification and an electronic device, to solve the technical problem in the prior art that a touch sensing signal and a drive signal share a first electrode of the apparatus for ultrasonic fingerprint identification, which is not conducive to chip circuit design, reduces detection sensitivity, and limits the application scenarios of the apparatus.

In a first aspect, the present disclosure provides an apparatus for ultrasonic fingerprint identification, arranged below a cover plate of an electronic device to implement ultrasonic fingerprint identification. The apparatus includes: an ultrasonic fingerprint identification chip, a matching layer stacked on the ultrasonic fingerprint identification chip, and a second electrode arranged with respect to the matching layer; wherein the ultrasonic fingerprint identification chip comprises a substrate, a first electrode, a pixel electrode array, and a piezoelectric layer; and the first electrode receives a drive signal to drive the piezoelectric layer to excite an ultrasonic signal, and the second electrode outputs a touch sensing signal to detect self-capacitance between the second electrode and a finger to perform fingerprint identification of the finger.

In a possible design, the matching layer comprises a first adhesive layer, an interlayer, and a second adhesive layer stacked sequentially from top to bottom, wherein the interlayer includes a conductive material with high acoustic impedance.

In a possible design, the second electrode is positioned in the interlayer.

In a possible design, the second electrode is arranged around the matching layer.

In a possible design, the first adhesive layer and the second adhesive layer include acrylic or epoxy resin.

In a possible design, the conductive material with high acoustic impedance comprises a metal.

In a possible design, thickness of the piezoelectric layer is 7 μm-11 μm.

In a possible design, the ultrasonic fingerprint identification chip comprises: the substrate, the pixel electrode array, the piezoelectric layer, and the first electrode stacked sequentially from the bottom up; or the first electrode, the piezoelectric layer, the pixel electrode array, and the substrate stacked sequentially from the bottom up.

In a possible design, an electrode layer is provided above or below the piezoelectric layer, and the first electrode is provided in the electrode layer.

In a possible design, the electrode layer includes a silver slurry, and the silver slurry has a thickness of 4 μm-30 μm.

In a possible design, the apparatus further comprises a circuit board pressed against and electrically connected to the ultrasonic fingerprint identification chip.

In a possible design, when the first electrode layer is stacked on the piezoelectric layer, the apparatus further comprises a reinforcing plate attached to the circuit board to fix the circuit board, and the ultrasonic fingerprint identification chip is arranged on a surface of the reinforcing plate.

In a second aspect, the present disclosure provides an electronic device, comprising: a cover plate, and any one possible apparatus for ultrasonic fingerprint identification provided in the first aspect; wherein the cover plate is configured to provide a pressing region of a finger and receive pressing of the finger; and the apparatus for ultrasonic fingerprint identification is arranged below the cover plate for detecting a fingerprint of the finger pressed against the cover plate.

In a possible design, the cover plate includes a conductive material or a non-conductive material.

In a possible design, when the cover plate includes the conductive material, an insulating coating is provided on a surface of the cover plate, and the cover plate has a thickness of 0.1 mm-1.5 mm.

In a possible design, when the cover plate includes the non-conductive material, a thickness of the cover plate is smaller than or equal to 3 mm.

In a possible design, the conductive material is a metal, and the non-conductive material is plastic or glass.

An apparatus for ultrasonic fingerprint identification and an electronic device are provided. The apparatus is arranged below a cover plate of the electronic device to implement ultrasonic fingerprint identification. The apparatus includes an ultrasonic fingerprint identification chip, a matching layer stacked on the ultrasonic fingerprint identification chip, and a second electrode arranged with respect to the matching layer. The ultrasonic fingerprint identification chip comprises a substrate, a first electrode, a pixel electrode array, and a piezoelectric layer. The first electrode receives a drive signal to drive the piezoelectric layer to excite an ultrasonic signal, and the second electrode receives a second drive signal to detect self-capacitance between the second electrode and a finger to implement fingerprint identification of the finger. The second electrode performing fingerprint identification based on an outputted touch sensing signal is designed to be separated from the first electrode receiving the drive signal, which, on the one hand, can avoid the presence of high voltage in the second electrode, thereby reducing voltage resistance design requirements of a chip circuit, and on the other hand, improves the sensitivity of self-capacitance detection of the finger, can expand and diversify application scenarios, and allow flexible regulation of the stacked layers for different application scenarios of the apparatus.

### BRIEF DESCRIPTION OF DRAWINGS

In order to clearly describe technical solutions of embodiments of the present disclosure or the prior art, drawings to be used in the description of the embodiments or the prior art will be briefly introduced below. Apparently, the drawings described below are some embodiments of the present disclosure. For those of ordinary skills in the art, other drawings may also be obtained based on these drawings without creative work.

FIG. 1 is a schematic diagram of an apparatus for ultrasonic fingerprint identification in the prior art;

FIG. 2 is a schematic structural diagram of an apparatus for ultrasonic fingerprint identification provided in an embodiment of the present disclosure;

FIG. 3 is a schematic structural diagram of another apparatus for ultrasonic fingerprint identification provided in an embodiment of the present disclosure;

FIG. 4 is a schematic structural diagram of still another apparatus for ultrasonic fingerprint identification provided in an embodiment of the present disclosure;

FIG. 5 is a schematic structural diagram of yet another apparatus for ultrasonic fingerprint identification provided in an embodiment of the present disclosure;

FIG. 6 is a top view of an apparatus for ultrasonic fingerprint identification provided in an embodiment of the present disclosure;

FIG. 7 is a schematic structural diagram of yet another apparatus for ultrasonic fingerprint identification provided in an embodiment of the present disclosure;

FIG. 8 is a schematic structural diagram of yet another apparatus for ultrasonic fingerprint identification provided in an embodiment of the present disclosure;

FIG. 9 is a schematic structural diagram of yet another apparatus for ultrasonic fingerprint identification provided in an embodiment of the present disclosure;

FIG. 10 is a schematic structural diagram of yet another apparatus for ultrasonic fingerprint identification provided in an embodiment of the present disclosure; and

FIG. 11 is a schematic structural diagram of yet another apparatus for ultrasonic fingerprint identification provided in an embodiment of the present disclosure.

Through the above drawings, definite embodiments of the present disclosure have been shown, and will be described in more detail below. These drawings and text descriptions are not intended to limit the scope of the conception of the present disclosure in any way, but are intended to illustrate the concepts of the present disclosure for those skilled in the art with reference to particular embodiments.

### DETAILED DESCRIPTION

Here, example embodiments will be described in detail, and examples thereof will be provided in the drawings. When the description below involves the drawings, like reference numerals refer to identical or similar elements in different drawings, unless otherwise indicated. The implementations described in the following example embodiments do not represent all implementations consistent with the present disclosure. On the contrary, they are merely method and apparatus examples consistent with some aspects of the present disclosure, as detailed in the appended claims.

The terms, such as “first,” “second,” “third,” and “fourth” (if present), in the description, the claims, and the above drawings of the present disclosure are used to distinguish between similar objects, and do not necessarily mean to limit a particular sequence or a sequential order. It should be understood that the data used in such a way is interchangeable under appropriate circumstances so that the embodiments of the present disclosure described herein can, for example, be implemented in a sequence other than those illustrated or described herein.

In addition, the terms “comprising” and “having”, as well as any variations thereof, are intended to encompass non-exclusive inclusions. For example, processes, methods, systems, products, or devices that include a series of steps or units are not necessarily limited to the explicitly listed steps or units, but may include other steps or units that are not explicitly listed or are inherent to these processes, methods, products, or devices.

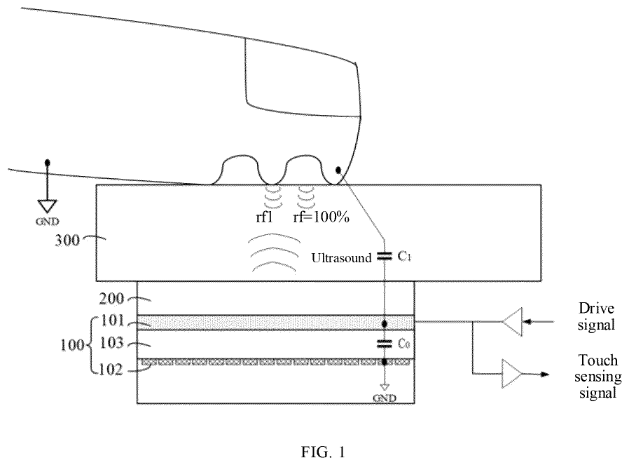

In the prior art as shown in FIG. 1, when a drive signal and a touch sensing signal share a first electrode 101 of an apparatus for ultrasonic fingerprint identification, there are the following problems: first, the drive signal usually drives a voltage of tens or even hundreds of volts. This voltage is too high for a touch sensing circuit connected with the touch sensing signal, which is thus not conducive to chip circuit design; second, the first electrode 101 and a pixel electrode array 102 sandwich a piezoelectric layer 103, which may be equivalent to a plate capacitor C0 with a very large capacitance value (usually up to 150 pF), while capacitance C1 generated by finger pressing is only of an order of magnitude of 1 pF, so that C0 is much larger than C1, and so that change of the touch sensing signal is insensitive to C1, that is, the presence of C0 will cause detection sensitivity of C1 to become very low, thereby reducing detection sensitivity of the apparatus for ultrasonic fingerprint identification; and moreover, the design of sharing the first electrode 101 must require the first electrode 101 to face the finger to implement finger touch detection, which is thus not conducive to flexible regulation of a stacked layer in a practical application of the apparatus for ultrasonic fingerprint identification, and imposes limitation on structure of the apparatus for ultrasonic fingerprint identification.

In view of the above problems in the prior art, the present disclosure provides an apparatus for ultrasonic fingerprint identification and an electronic device. The inventive concept of the apparatus for ultrasonic fingerprint identification provided in the present disclosure is to: separate an electrode receiving a drive signal from an electrode outputting a touch sensing signal, that is, additionally provide a second electrode, and receive the drive signal using an original first electrode to generate and receive ultrasonic signals. The second electrode is connected to a detection circuit of the touch sensing signal, and capacitance change between the second electrode and a finger is detected by detecting the touch sensing signal to ascertain finger touch sensing. The second electrode is designed to be separated from the first electrode, which, on the one hand, can avoid presence of high voltage in the second electrode because the second electrode does not need to withstand high voltage of the drive signal, thereby reducing voltage resistance design requirements of a chip circuit, and on the other hand, improves sensitivity of self-capacitance detection of the finger, can further expand and diverse the application scenarios of the apparatus, and allow flexible regulation of stacked layers for different application scenarios.

Technical solutions of the present disclosure and how the technical solutions of the present disclosure solve the above technical problems will be described in detail below with reference to specific embodiments. Some of the specific embodiments below may be combined with each other, and same or similar concepts or processes may not be repeated in some embodiments. Embodiments of the present disclosure will be described below with reference to the drawings.

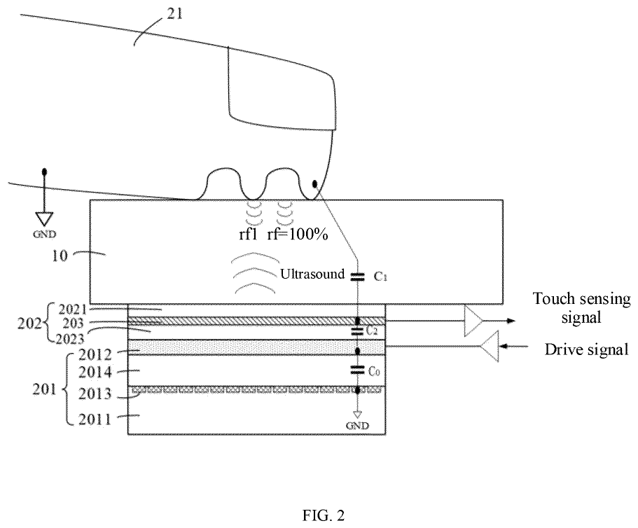

FIG. 2 is a schematic structural diagram of an apparatus for ultrasonic fingerprint identification provided in an embodiment of the present disclosure. As shown in FIG. 2, an apparatus for ultrasonic fingerprint identification is arranged below a cover plate 10 of an electronic device to implement ultrasonic fingerprint identification.

The apparatus for ultrasonic fingerprint identification comprises: an ultrasonic fingerprint identification chip 201, a matching layer 202 stacked on the ultrasonic fingerprint identification chip 201, and a second electrode 203 arranged with respect to the matching layer 202.

The ultrasonic fingerprint identification chip 201 comprises a substrate 2011, a first electrode 2012, a pixel electrode array 2013, and a piezoelectric layer 2014.

Optionally, the substrate 2011 may be a silicon substrate formed through a Complementary Metal-Oxide-Semiconductor (CMOS) process.

The apparatus for ultrasonic fingerprint identification works in an ultrasonic mode. The first electrode 2012 receives a drive signal to drive the piezoelectric layer 2014 to excite an ultrasonic signal. The ultrasonic signal is reflected from a finger 21 to form an ultrasonic signal carrying fingerprint information, that is, an ultrasonic fingerprint feedback signal, which is used to identify the fingerprint information of the finger. During touch detection, a touch sensing signal is characterized by change of self-capacitance (capacitance of the electrode itself to reference ground GND, abbreviated as self-capacitance) C1 between the second electrode 203 and the finger 21. The second electrode 203 outputs the touch sensing signal to detect the change of the self-capacitance C1 formed between the second electrode 203 and the finger 21, thereby implementing touch detection of the finger 21.

It can be seen that the first electrode 2012 is configured to receive the drive signal, to generate an ultrasonic signal, and to receive the ultrasonic fingerprint feedback signal carrying a fingerprint signal returned from the finger, while the second electrode 204 is configured to receive the touch sensing signal for touch detection, to separate the shared electrode between the drive signal and the touch sensing signal in the prior art, so that the first electrode 2012 and the second electrode 203 each perform their own functions, and the second electrode 203 does not need to withstand high voltage of the drive signal, thereby avoiding disadvantages of the high voltage on the chip circuit design. Moreover, a plate parasitic capacitance will be formed between the second electrode 203 and the first electrode 2012, and can be reduced by controlling the thickness and the dielectric constant of the material between the two electrodes, thereby reducing the parasitic capacitance of the second electrode 203 to ground (GND), and preventing excessive parasitic capacitance from reducing detection sensitivity of the self-capacitance C1.

In addition, because the first electrode 2012 is designed to be separated from the second electrode 203, the first electrode 2012 is no longer required to face the finger 21, thereby broadening flexible regulation of stacked layers in different application scenarios.

For example, as shown in FIG. 2, the pixel electrode array 2013 is arranged above the substrate 2011, the piezoelectric layer 2014 is stacked on the pixel electrode array 2013, and the first electrode 2012 is stacked on the piezoelectric layer 2014, that is, the substrate 2011, the pixel electrode array 2013, the piezoelectric layer 204, and the first electrode 2012 are stacked sequentially from the bottom up to form the ultrasonic fingerprint identification chip 201 with a front-mounted structure.

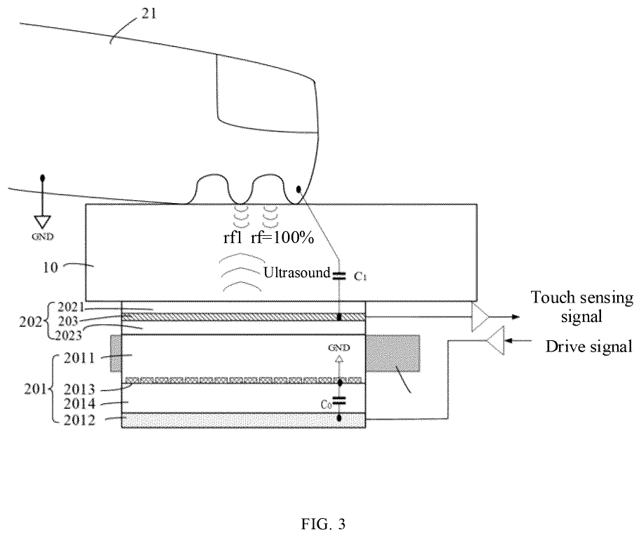

In some embodiments, as shown in FIG. 3, the ultrasonic fingerprint identification chip 201 may further have a flip-chip structure, that is, the first electrode 2012 is the bottom layer, the piezoelectric layer 2014 is stacked on the first electrode 2012, the pixel electrode array 2013 is stacked on the piezoelectric layer 2014, and the substrate 2011 is stacked on the pixel electrode array 2013, that is, the first electrode 2012, the piezoelectric layer 2014, the pixel electrode array 2013, and the substrate 2011 are stacked sequentially from the bottom up.

Further, in the ultrasonic fingerprint identification chip 201 with the flip-chip structure, the first electrode 2012 is completely unable to sense the capacitance C1, but the second electrode 203 can still sense the capacitance C1 normally. Moreover, in this case, the parasitic capacitance of the second electrode 203 to GND can be significantly reduced, which is conductive to improving the detection sensitivity of the capacitance C1.

Further referring to FIGS. 2 and 3, the second electrode 203 may be arranged in the matching layer 202.

For example, the matching layer 202 is composed of an interlayer sandwiched between two adhesive layers. Specifically, the matching layer 202 comprises a first adhesive layer 2021, an interlayer, and a second adhesive layer 2023 stacked sequentially from top to bottom.

The matching layer 202 is configured to implement acoustic impedance matching between the ultrasonic fingerprint identification chip 201 and the cover plate 10, to improve energy of ultrasound penetrating into the cover plate 10.

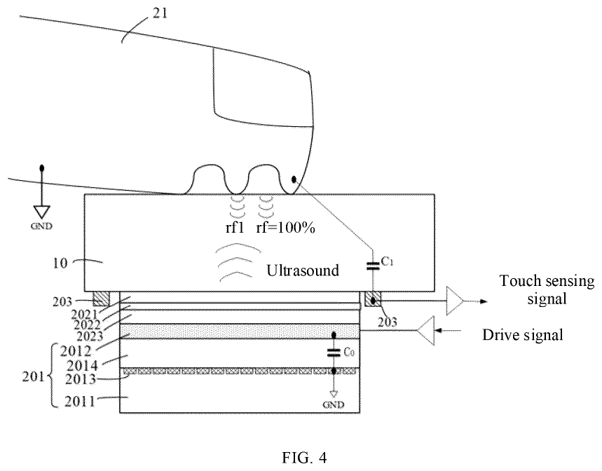

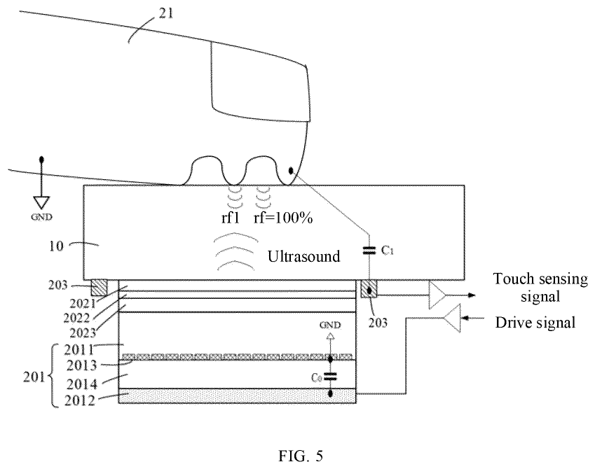

Thicknesses of the adhesive layers and the interlayer are regulated, to regulate acoustic matching effects of the matching layer 202. The interlayer is as shown by the interlayer 2022 in FIGS. 4 and 5.

In some embodiments, the first adhesive layer 2021 and the second adhesive layer 2023 may include, e.g., acrylic or epoxy resin with a thickness of 3-10 μm. The interlayer may be a conductive material with high acoustic impedance, for example, a metal such as copper, aluminum, gold, silver, or stainless steel with a thickness of 5-40 μm.

In some embodiments, the matching layer 202 may also be formed by mixing high-impedance powder and epoxy resin. Proportion of the high-impedance powder is regulated, to regulate acoustic impedance of the matching layer 202.

In a possible design, as shown in FIGS. 2 and 3, the second electrode 203 may be arranged in the interlayer, so that the second electrode 203 serves as a component of the matching layer 202.

Optionally, in some embodiments, the second electrode 203 may also be separated from the matching layer 202. As shown in FIGS. 4 and 5, the second electrode 203 is arranged around the matching layer 202. For example, the second electrode 203 may be a ring-shaped electrode arranged around the matching layer 202.

It should be noted that FIG. 4 is a diagram showing that the second electrode 203 is arranged around the matching layer 202 in an ultrasonic fingerprint identification chip 201 with a front-mounted structure, and FIG. 5 is a diagram showing that the second electrode 203 is arranged around the matching layer 202 in an ultrasonic fingerprint identification chip 201 with a flip-chip structure.

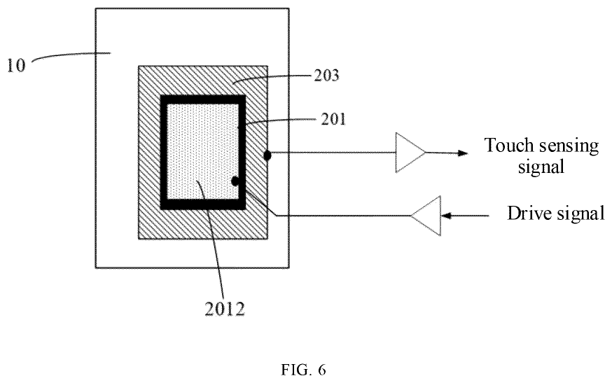

Referring to FIG. 6, FIG. 6 is a top view of the second electrode 203 arranged around the matching layer 202. The second electrode 203 is removed from the matching layer 202 and is arranged around the matching layer 202, which may also be regarded as around the ultrasonic fingerprint identification chip 201, thereby further reducing the parasitic capacitance of the second electrode 203 to GND, and further avoiding the influence of the second electrode 203 on the matching layer 202.

In a possible design, the piezoelectric layer 2014 of the apparatus for ultrasonic fingerprint identification provided in an embodiment of the present disclosure may be a piezoelectric film material with piezoelectric effects and with a thickness of 7 μm-11 μm.

In a possible design, the first electrode 2012 of the apparatus for ultrasonic fingerprint identification provided in an embodiment of the present disclosure may be arranged in an electrode layer. For example, the electrode layer is arranged above or below the piezoelectric layer 2014, and the first electrode 2012 is arranged in the electrode layer.

Specifically, an electrode layer such as the front-mounted structure of the ultrasonic fingerprint identification chip 201 is arranged above the piezoelectric layer 2014, and an electrode layer such as the flip-chip structure of the apparatus for ultrasonic fingerprint identification is arranged below the piezoelectric layer 2014.

Optionally, the electrode layer may include a silver slurry, and the silver slurry may have a thickness of 4 μm-30 μm. Generally, the larger the thickness of the silver slurry is, the lower the corresponding operating frequency is; and the smaller the thickness is, the higher the operating frequency is.

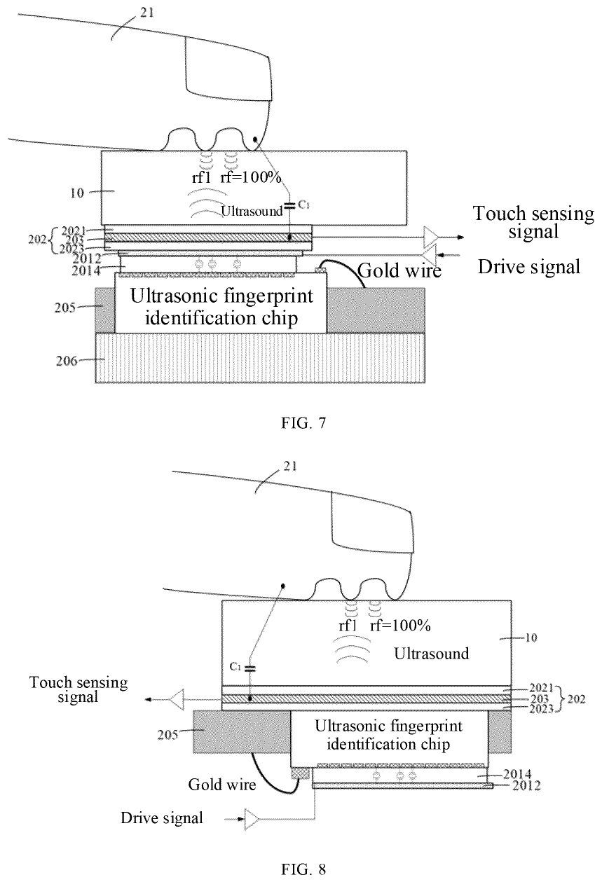

The apparatus for ultrasonic fingerprint identification provided in the above embodiments may further comprise: a circuit board 205 as shown in FIGS. 7-10.

The circuit board 205 is pressed against and electrically connected to the ultrasonic fingerprint identification chip 201. For example, the ultrasonic fingerprint identification chip may be connected to circuit of the circuit board 205 through a gold wire (as shown in FIGS. 7-10) bonding process to electrically connect the two.

Optionally, the circuit board 205 may be, for example, a flexible printed circuit (abbreviated as FPC), which is a highly reliable and superexcellent flexible printed circuit board made from polyimide or polyester film as a base material.

Based on the above embodiments, optionally, if the first electrode 2012 is stacked on the piezoelectric layer 2014, that is, the ultrasonic fingerprint identification chip 201 with the front-mounted structure, the apparatus for ultrasonic fingerprint identification further comprises a reinforcing plate 206.

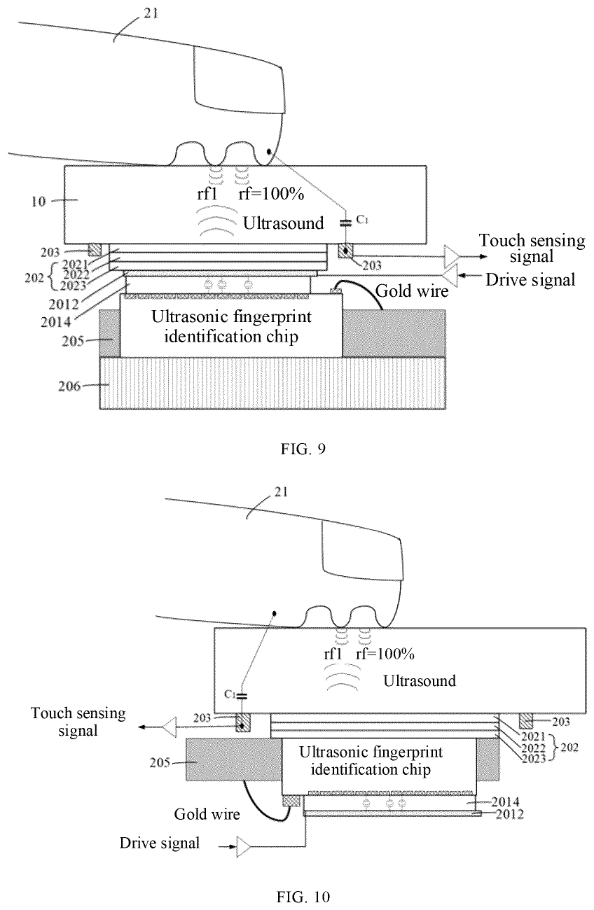

As shown in FIGS. 7 and 9, the ultrasonic fingerprint identification chip 201 is arranged on a surface of the reinforcing plate 206, and the reinforcing plate 206 is attached to the circuit board 205 to fix the circuit board 205.

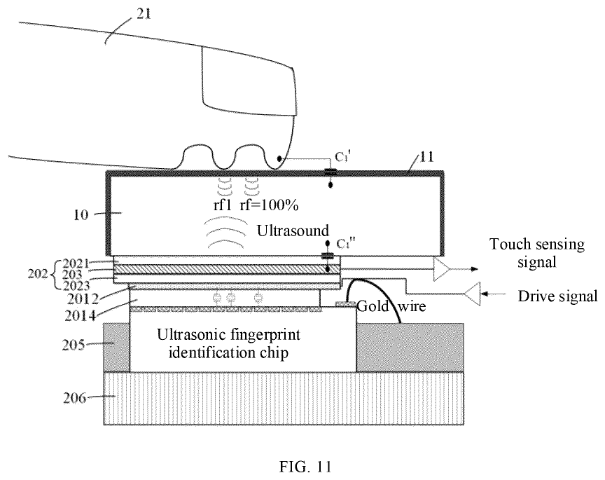

It should be noted that when the ultrasonic fingerprint identification chip 201 as shown in FIGS. 8 and 10 has a flip-chip structure, the ultrasonic fingerprint identification chip 201 is directly attached to the matching layer 202, the reinforcing plate 205 is omitted, and the reinforcing plate 205 does not need to be provided.

As can be seen from the description of the above embodiments, the apparatus for ultrasonic fingerprint identification provided in the embodiments of the present disclosure may be arranged below a cover plate of an electronic device to implement ultrasonic fingerprint identification, and comprises: an ultrasonic fingerprint identification chip, a matching layer stacked on the ultrasonic fingerprint identification chip, and a second electrode arranged with respect to the matching layer. The ultrasonic fingerprint identification chip comprises a substrate, a first electrode, a pixel electrode array, and a piezoelectric layer. The first electrode receives a drive signal to drive the piezoelectric layer to excite an ultrasonic signal, and the second electrode receives a second drive signal to detect self-capacitance between the second electrode and a finger to implement fingerprint identification of the finger.

The second electrode performing fingerprint identification based on an outputted touch sensing signal is designed to be separated from the first electrode receiving the drive signal, which, on the one hand, can avoid presence of high voltage in the second electrode, thereby reducing voltage resistance design requirements of a chip circuit, and on the other hand, improves sensitivity of self-capacitance detection of the finger, can further broaden and diverse application scenarios of the apparatus, and allows the flexible regulation of stacked layers in different application scenarios.

Based on the above embodiments, an embodiment of the present disclosure further provides an electronic device, which may comprise a cover plate 10 and the apparatus for ultrasonic fingerprint identification as provided in the above embodiments.

The cover plate 10 is configured to provide a pressing region of a finger 21 and receive pressing of the finger 21; and the apparatus for ultrasonic fingerprint identification is arranged below the cover plate 10 for detecting a fingerprint of the finger 21 pressed against the cover plate 10.

Further, the cover plate 10 provided in the above embodiments may include a conductive material, or may include a non-conductive material.

In some embodiments, if the cover plate 10 includes the conductive material, as shown in FIG. 11, in order to prevent the conductive cover plate from being short-circuited to ground (GND), it is usually necessary to additionally provide an insulating coating 11 on a surface of the cover plate 10. The finger 21 can press the insulating coating 11, can change capacitance C1 between the second electrode 203 and the finger 21, and can also implement fingerprint detection by finger pressing. Capacitors C1′ and C1″ in FIG. 11 are connected in parallel to form capacitor C1.

It should be noted that FIG. 11 is only an illustration based on FIG. 7, but does not limit it. That is, if the cover plate 10 shown in the above embodiments includes the conductive material, the insulating coating 11 needs to be provided on the surface thereof to prevent the cover plate 10 from being short-circuited to ground.

In a possible design, if the cover plate 10 includes the conductive material, such as a metal, thickness of the cover plate 10 may be set to 0.1 mm-1.5 mm.

In some embodiments, if the cover plate includes the non-conductive material such as plastic or glass, thickness of the cover plate 10 may be smaller than or equal to 3 mm.

In some embodiments, the apparatus for ultrasonic fingerprint identification may be arranged on any surface where the electronic device interacts with a user, including but not limited to front of the electronic device.

In some embodiments, type of the electronic device may be, for example, a smart door lock, a smart switch, a smart wearable device, or other devices with a non-OLED screen to implement finger touch detection function accordingly, and is not limited in the embodiments of the present disclosure.

Other embodiments of the present disclosure will be apparent to those skilled in the art from consideration of the specification and practice of the invention disclosed herein. The present disclosure is intended to cover any variations, uses, or adaptive changes of the present disclosure, which follow the general principles of the present disclosure and include common knowledge or customary technical means in the art that is not disclosed in the present disclosure. The specification and the embodiments are only regarded as examples, and the true scope and spirit of the present disclosure are indicated by the claims.

It should be understood that the present disclosure is not limited to the exact construction that has been described above and shown in the drawings, and that various modifications and alterations may be made without departing from the scope thereof. The scope of the present disclosure is limited only by the appended claims.

1. An apparatus for ultrasonic fingerprint identification, arranged below a cover plate of an electronic device to implement ultrasonic fingerprint identification, the apparatus comprising: an ultrasonic fingerprint identification chip, a matching layer stacked on the ultrasonic fingerprint identification chip, and a second electrode arranged with respect to the matching layer; wherein
the ultrasonic fingerprint identification chip comprises a substrate, a first electrode, a pixel electrode array, and a piezoelectric layer; and
the first electrode is configured to receive a drive signal to drive the piezoelectric layer to excite an ultrasonic signal, and the second electrode is configured to output a touch sensing signal to detect self-capacitance between the second electrode and a finger to perform fingerprint identification of the finger.

2. The apparatus for ultrasonic fingerprint identification according to claim 1, wherein the matching layer comprises a first adhesive layer, an interlayer, and a second adhesive layer stacked sequentially from top to bottom, the interlayer comprises a conductive material with high acoustic impedance.

3. The apparatus for ultrasonic fingerprint identification according to claim 2, wherein the second electrode is positioned in the interlayer.

4. The apparatus for ultrasonic fingerprint identification according to claim 2, wherein the second electrode is arranged around the matching layer.

5. The apparatus for ultrasonic fingerprint identification according to claim 2, wherein the first adhesive layer and the second adhesive layer includes acrylic or epoxy resin.

6. The apparatus for ultrasonic fingerprint identification according to claim 2, wherein the conductive material with high acoustic impedance comprises a metal.

7. The apparatus for ultrasonic fingerprint identification according to claim 1, wherein a thickness of the piezoelectric layer is 7 μm-11 μm.

8. The apparatus for ultrasonic fingerprint identification according to claim 1, wherein the ultrasonic fingerprint identification chip comprises:
the substrate, the pixel electrode array, the piezoelectric layer, and the first electrode stacked sequentially from the bottom up; or
the first electrode, the piezoelectric layer, the pixel electrode array, and the substrate stacked sequentially from the bottom up.

9. The apparatus for ultrasonic fingerprint identification according to claim 8, wherein an electrode layer is provided above or below the piezoelectric layer, and the first electrode is provided in the electrode layer.

10. The apparatus for ultrasonic fingerprint identification according to claim 9, wherein the electrode layer comprises a silver slurry, and the silver slurry has a thickness of 4 μm-30 μm.

11. The apparatus for ultrasonic fingerprint identification according to claim 10, wherein the apparatus further comprises a circuit board pressed against and electrically connected to the ultrasonic fingerprint identification chip.

12. The apparatus for ultrasonic fingerprint identification according to claim 11, wherein when the first electrode layer is stacked on the piezoelectric layer, the apparatus further comprises a reinforcing plate attached to the circuit board to fix the circuit board, and the ultrasonic fingerprint identification chip is arranged on a surface of the reinforcing plate.

13. An electronic device, comprising: a cover plate, and the apparatus for ultrasonic fingerprint identification according to claim 1; wherein
the cover plate is configured to provide a pressing region of a finger and receive pressing of the finger; and
the apparatus for ultrasonic fingerprint identification is arranged below the cover plate for detecting a fingerprint of the finger pressed against the cover plate.

14. The electronic device according to claim 13, wherein the cover plate comprises a conductive material or a non-conductive material.

15. The electronic device according to claim 14, wherein the cover plate comprises the conductive material, an insulating coating is provided on a surface of the cover plate, and the cover plate has a thickness of 0.1 mm-1.5 mm.

16. The electronic device according to claim 14, wherein the cover plate comprises the non-conductive material, thickness of the cover plate is smaller than or equal to 3 mm.

17. The electronic device according to claim 14, wherein the conductive material is a metal, and the non-conductive material is plastic or glass.
